(19) United States
(12) Patent Application Publication
(10) Pub. No.: US 2024/0419597 A1
(43) Pub. Date: Dec. 19, 2024

(54) EFFECTIVE SET SAMPLING AND SET-DUELING IN LARGE DISTRIBUTED SYSTEM LEVEL CACHES

(71) Applicant: Microsoft Technology Licensing, LLC, Redmond, WA (US)

(72) Inventors: Adithya NALLAN CHAKRAVARTHI, Cary, NC (US); Jason Lawrence PANAVICH, Raleigh, NC (US)

(21) Appl. No.: 18/336,661

(22) Filed: Jun. 16, 2023

(51) Int. Cl. G06F 12/084; G06F 12/0846

(52) U.S. Cl. CPC G06F 12/084; G06F 12/0846

(57) ABSTRACT

Systems and methods for effective set sampling and set-dueling in large distributed system level caches are described. An example method includes a shared cache instance (SCI), from among a plurality of SCIs, receiving a request associated with a thread, where the request comprises policy information for specifying at least one of two cache algorithms for implementation by the SCI for any requests associated with the thread. The method further includes the SCI implementing the at least one of the two cache algorithms specified by the policy information received as part of the request associated with the thread unless the SCI is identified as a delegated shared cache instance, from among the SCIs, for determining a winner between the two cache algorithms for use with any requests associated with the thread.

### BACKGROUND

A multi-core computing system may support many applications, which may be executed as threads by cores associated with one or more processors associated with the computing system. The cores may access local caches and shared caches. The shared caches may be subject to various cache-related policies, including cache replacement policies (also referred to as cache replacement algorithms).

While some of these cache replacement algorithms, such as the least recently used (LRU) algorithm, perform well with applications that have working sets that fit within a single cache, they might not perform well in systems with large distributed system level caches being accessed by multiple threads. In addition, other cache-related algorithms, such as insertion algorithms and allocation algorithms may also perform poorly in systems with large distributed system level caches being accessed by multiple threads. Accordingly, there is a need for systems and methods for effective set sampling and set-dueling in large distributed system level caches.

### SUMMARY

In one example, the present disclosure relates to a method for selecting a cache algorithm in a system having a plurality of cores and a plurality of shared cache instances accessible to any of the plurality of cores, where the system is configurable to execute threads. The method may include a shared cache instance, from among the plurality of shared cache instances, receiving a request associated with a thread, where the request comprises policy information for specifying at least one of two cache algorithms for implementation by the shared cache instance for any requests associated with the thread.

The method may further include the shared cache instance implementing the at least one of the two cache algorithms specified by the policy information received as part of the request associated with the thread unless the shared cache instance is identified as a delegated shared cache instance, from among the shared cache instances, for determining a winner between the two cache algorithms for use with any requests associated with the thread.

In another example, the present disclosure relates to a system having a plurality of cores and a plurality of shared cache instances accessible to any of the plurality of cores, where the system is configurable to execute threads. The system may include a shared cache instance, from among the plurality of shared cache instances, to receive a request associated with a thread, where the request comprises policy information for specifying at least one of two cache algorithms for implementation by the shared cache instance for any requests associated with the thread.

The system may further include shared cache instance circuitry, associated with the shared cache instance, configured to process the policy information received as part of the request associated with the thread. The shared cache instance circuitry may further be configured to instruct the shared cache instance to implement the at least one of the two cache algorithms unless the shared cache instance is identified by the shared cache instance circuitry as a delegated shared cache instance, from among the shared cache instances, for determining a winner between the at least two cache algorithms for use with any requests associated with the thread.

In yet another example, the present disclosure relates to a method for selecting a cache algorithm in a system having a plurality of cores and a plurality of shared cache instances accessible to any of the plurality of cores, where the system is configurable to execute threads. The method may include designating a shared cache instance as a first delegated shared cache instance for determining a winner between at least two cache algorithms for access requests associated with a thread. The method may further include delegating another shared cache instance as a second delegated shared cache instance for determining the winner between the at least two cache algorithms for access requests associated with the thread.

The method may further include communicating policy information specifying the winner between the at least two cache algorithms to each of the plurality of cores. The method may further include a shared cache instance, from among the plurality of shared cache instances, upon receiving a request for cache access associated with the thread implementing one of the at least two cache algorithms specified by the policy information received as part of the request for the cache access unless the shared cache instance receiving the request is identified as the first delegated shared cache instance or the second delegated shared cache instance.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present disclosure is illustrated by way of example and is not limited by the accompanying figures, in which like references indicate similar elements. Elements in the figures are illustrated for simplicity and clarity and have not necessarily been drawn to scale.

FIG. 1 is a block diagram of an example system in which effective set sampling and set-dueling is implemented;

FIG. 2 shows a flow chart for selecting a replacement policy for use with a thread as part of the implementation of effective set sampling and set-dueling in accordance with one example;

FIG. 3 shows example shared cache instance (SCI) circuitry for implementing effective set sampling and set-dueling;

FIG. 4 shows a flow chart for updating the dynamic algorithm bit (DAB) and training the set dueling counter as part of the implementation of effective set sampling and set-dueling in accordance with one example;

FIGS. 5A-C show three different examples of layouts of leader sets and follower sets from a thread's perspective for implementing effective set sampling and set-dueling;

FIG. 6 shows another example shared cache instance (SCI) circuitry for implementing effective set sampling and set-dueling;

FIG. 7 shows a flow chart of an example method for selecting a cache algorithm based on effective set sampling and set-dueling; and

FIG. 8 shows a flow chart of another example method for selecting a cache algorithm based on effective set sampling and set-dueling.

### DETAILED DESCRIPTION

Examples described in this disclosure relate to systems and methods for effective set sampling and set-dueling in large distributed system level caches. Certain examples relate to systems with multiple cores in a multi-threaded computing system. The multi-threaded computing system may be a standalone computing system or may be part (e.g., a server) of a public cloud, a private cloud, or a hybrid cloud. The public cloud includes a global network of servers that perform a variety of functions, including storing and managing data, running applications, and delivering content or services, such as streaming videos, electronic mail, office productivity software, or social media. The servers and other components may be located in data centers across the world. While the public cloud offers services to the public over the Internet, businesses may use private clouds or hybrid clouds. Both private and hybrid clouds also include a network of servers housed in data centers. Applications may be executed using compute and memory resources of the standalone computing system or a computing system in a data center. As used herein, the term “application” encompasses, but is not limited to, any executable code (in the form of hardware, firmware, software, or in any combination of the foregoing) that implements a functionality, a virtual machine, a client application, a service, a micro-service, a container, or a unikernel for serverless computing. Alternatively, applications may be executing on hardware associated with an edge-compute device, on-premises servers, or other types of systems, including communications systems, such as base stations (e.g., 5G or 6G base stations).

Computing systems contain several types of memories, including caches. Caches help alleviate the long latency associated with access to main memories (e.g., double data rate (DDR) dynamic random access memory (DRAM)) by providing data with low latency. A processor may have access to a cache hierarchy, including L1 caches, L2 caches, and L3 caches, where the L1 caches may be closest to the processing cores and the L3 caches may be the furthest. Data access may be made to the caches first and if the data is found in the cache, then it is viewed as a hit. If the data, however, is not found in the cache, then it is viewed as a miss, and the data will need to be loaded from the main memory (e.g., the DRAM). Managing caches, including implementing the various cache policies, is a difficult problem in systems that include multiple cores and have shared system level caches.

Examples described herein relate to systems and methods for dynamic set sampling (DSS) and set-dueling in distributed system level caches (SLCs) shared by many cores. Certain conventional methods distribute sets across multiple shared cache instances (SCIs), but this approach reduces accuracy since there is not enough resolution to capture the performance of each thread per SCI, and the information across each SCI is not combined per thread.

In a large system hosting multiple users, shared cache resources are contested by numerous applications. These applications might have different access patterns to the system level cache (SLC), and require that the SLC manage the cache lines owned by one application differently from another. One example of cache management is a cache replacement algorithm. Different applications will prefer different cache replacement algorithms. Certain caches may implement dynamic replacement algorithms, such as dynamic re-reference interval prediction (DRRIP) and dynamic insertion policy (DIP), where the cache will change the policy to one that improves the hit-rate of the cache for the application currently being executed by the core(s).

Dynamic replacement algorithms may accomplish this by dynamic set sampling (DSS) and set-dueling. DSS leverages the understanding that the behavior of a small portion of the cache is statistically sufficient to approximate the behavior of the entire cache. For example, in a cache with 2048 sets, 32-64 sets (referred to as the leader sets) may be sufficient. With DSS, the cache would always perform a replacement algorithm “ReplA” on some of the leader sets (e.g., 32 leader sets), and “ReplB” on some other leader sets (e.g., another 32 leader sets) to approximate the cache behavior as if the entire cache were performing ReplA or ReplB. Set-dueling makes ReplA and ReplB compete against each other to identify the winner that provides the highest hit-rate (or equivalently, the lowest miss-rate). A dueling counter may be used to implement set-dueling. A miss in the leader sets of ReplA will decrement the dueling counter, while a miss in the leader sets of ReplB will increment the dueling counter. In this manner, the dueling counter measures the policy that generates the most misses, and thus the opposite replacement policy is chosen to maximize hits. The chosen replacement policy is implemented on the rest of the sets in the cache (referred to as the follower sets).

In the case of multi-core systems, different applications could prefer different replacement algorithms. Thread-aware (TA) dynamic replacement algorithms such as TA-DRRIP and TA-DIP can identify the optimum replacement algorithm for a particular thread by having leader sets per thread, per policy. A leader set for thread 0 and having a replacement algorithm A (ReplA) will statically implement ReplA for lines that are sourced from thread 0, while using the winning policy determined by the other thread's leader sets for all other threads. Therefore, for effective thread-aware replacement algorithms one would need 64 total leader sets for a 1-thread system per cache instance, 128 leader sets for a 2-thread system per cache instance, 256 sets for a 4-thread system, and all 2048 sets for a 32-thread system. To support higher thread counts than 32, one would need to reduce the number of leader sets, reducing accuracy, or group threads into clusters and pay a potential performance penalty.

In addition, conventional many-core systems cannot implement the traditional TA-DRRIP/TA-DIP algorithms for high core-count systems while maintaining effective sampling efficiency. One possible solution is to use information from the core's private cache to pre-emptively select the shared system level cache replacement algorithm. While this approach may work in certain situations, it has several disadvantages. First, this approach removes the information that is only present in the shared system level cache. This approach also reduces the efficiency of filtering by the cache at the locality only seen by the shared system level cache. Finally, this approach ignores the effect of multiple threads competing and co-existing in the shared cache space.

Examples described herein address the high core count sampling problem. These systems and methods also minimize the required dueling hardware per cache instance, while adding only minimal hardware to the cache controllers. Finally, these systems and methods add only one or a few more additional bits to the payload of messages being sent in the fabric. As described herein, in certain examples, the problem of having a limited number of sets in a particular shared cache instance (SCI) to identify the best algorithm for all threads is overcome by delegating the SCI to identify the set-dueling winner for only the nearest physical core/thread. Since cache accesses for a large distributed cache are spread out, to maintain sufficient dynamic set sampling the number of leader sets per SCI are increased. In one example, the number of leader sets per SCI is increased from 32-64 per 2048 sets (per thread) to around 256-512 per 2048 sets. The proposed systems and methods allow identification of potentially the best shared system level cache algorithm for a particular thread in the presence of other competing threads.

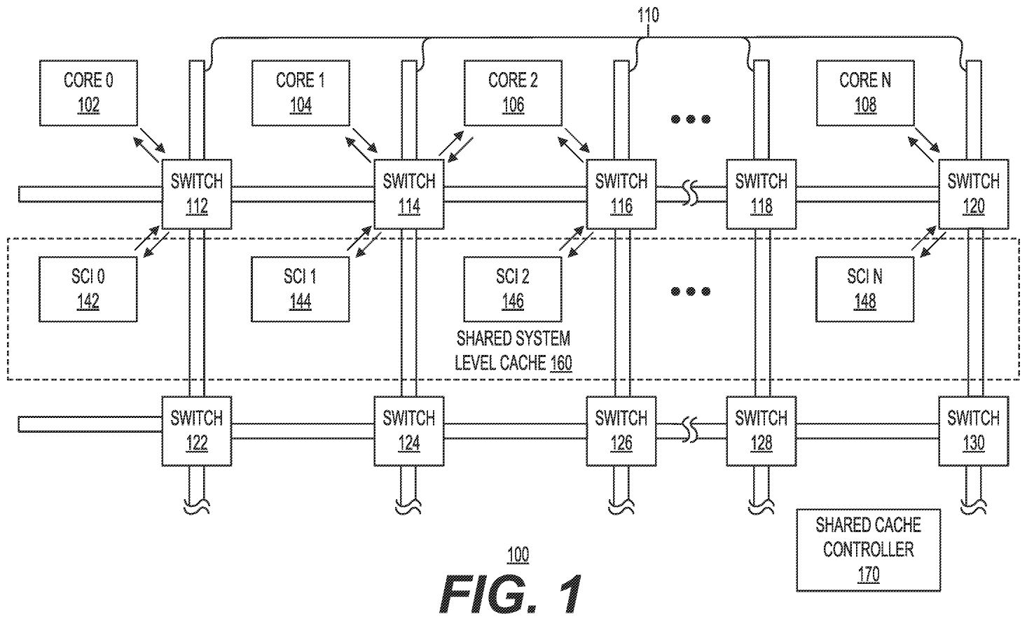

FIG. 1 is a block diagram of an example system 100 in which effective set sampling and set-dueling is implemented. System 100 includes several processing cores (e.g., core 0 102, core 1 104, core 2 106, and core N 108) coupled with the components of a distributed shared system level cache (SSLC) 160 via interconnect 110. Although example system 100 shows only the shared system level cache (SSLC) 160, each of the cores may have access to other local and/or shared caches (e.g., level 1 and level 2 caches (not shown)). In one example, the shared system level cache (SSLC) 160 may be viewed as the level 3 cache in the cache hierarchy assuming it has level 1 and level 2 caches, as well. System 100 further includes a shared cache controller 170, which can be used to configure the caches at system start up or at reset, as needed. Interconnect 110 includes several switches (e.g., switches 112, 114, 116, 118, 120, 122, 124, 126, 128, and 130) allowing for the exchange of both commands (e.g., read access or write access commands) and data among the cores and the shared cache instances included as part of SSLC 160. As an example, switch 112 allows core 0 102 to access interconnect 110 and access a shared system level cache. SSLC 160 includes several shared cache instances (SCIs) and delegated shared cache instances (DSCIs). Each shared cache instance includes an SCI controller (not shown), which is responsible for managing the functionality of the specific SCI.

With continued reference to FIG. 1, system 100 shows one SCI per thread. In this example, SCI 0 142 is a delegated shared cache instance for thread 0 (the number 0 in this case acts as a thread identifier). SCI 1 144 is a delegated shared cache instance for thread 1, SCI 2 146 is a delegated shared cache instance for thread 2, and SCI N 148 is a delegated shared cache instance for thread N. Accordingly, in this example, there is one to one mapping between a thread and a delegated shared cache instance (DSCI). In other words, there is one SCI that is delegated to have the leader sets for a given thread. System 100, however, is not limited to this specific arrangement. Two or more delegated shared cache instances (DSCIs) may also be used per thread. As such, a delegated shared cache instance is a “delegated” shared cache instance for a given thread and is merely a shared cache instance for the threads for which it is not the delegated shared cache instance.

The delegated shared instance (DSCI) for a specific thread is used to decide the replacement algorithm to be implemented across the entire shared cache for all accesses from the thread. Thus, in this example, SCI 0 142 will decide the replacement algorithm to be implemented across SSLC 160 for all accesses from thread 0. SCI 1 144 will decide the replacement algorithm to be implemented across SSLC 160 for all accesses from thread 1. SCI 2 146 will decide the replacement algorithm to be implemented across SSLC 160 for all accesses from thread 2. SCI N 148 will decide the replacement algorithm to be implemented across SSLC 160 for all accesses from thread N. The information for choosing the winning policy for the thread (referred to as the dynamic algorithm bit(s) (DAB)) is communicated to the physical core for thread 0 on a response/return message to the core. On receiving this response message, the core will store and transmit the respective DAB on all future command messages to any shared cache instance. If the shared cache instance that received the message, including the DAB, is the DSCI for that particular thread, then the DAB is disregarded. Otherwise, the SCI will read the DAB and perform the algorithm indicated in the message. This delegated dynamic cache arrangement absolves each shared cache instance (SCI) of the responsibility of identifying the best performing algorithm for each thread. Instead, the responsibility for identifying the best performing algorithm for a thread (e.g., thread 0) is delegated to a particular SCI (e.g., SCI 0 142 for thread 0 in this example). However, the delegated dynamic cache arrangement is not restricted to having one DSCI per core. Instead, other mappings of core(s)/thread(s) to DSCI(s) can also be used. As one example, core 0 102 may have set-dueling hardware in two different delegated shared cache instances (e.g., SCI 0 142 and SCI 1 144). Similarly core 1 104 may have set-dueling hardware in two other delegated shared cache instances (e.g., SCI 1 144 and SCI 2 146). In this manner, a single thread may rely upon two delegated shared cache instances (DSCIs) for identifying the best cache replacement algorithm for the thread. Other mappings among cores/threads and DSCIs may also be used. As an example, threads may share a delegated shared cache instance. Thus, both thread 0 and thread 1 may share one SCI (e.g., SCI 0 142).

The communication of the best algorithm is choreographed by the movement of the DABs across the system. In one example, to minimize the overhead of the communication (e.g., where the new policy has to be communicated to the core and then transmitted to the SCIs), this example proposes to choose the DSCIs for a particular thread/core by closest proximity. It is understood in this example though, that some requests already in flight from the core to other SCIs with the stale DAB will be installed sub-optimally. Although FIG. 1 shows a certain number of cores and caches that are arranged in a certain way, system 100 may include other cores and caches that are arranged differently. In addition, although FIG. 1 describes system 100 in the context of cache replacement algorithms, system 100 can also be configured for use with other cache algorithms, including insertion algorithms and allocation algorithms.

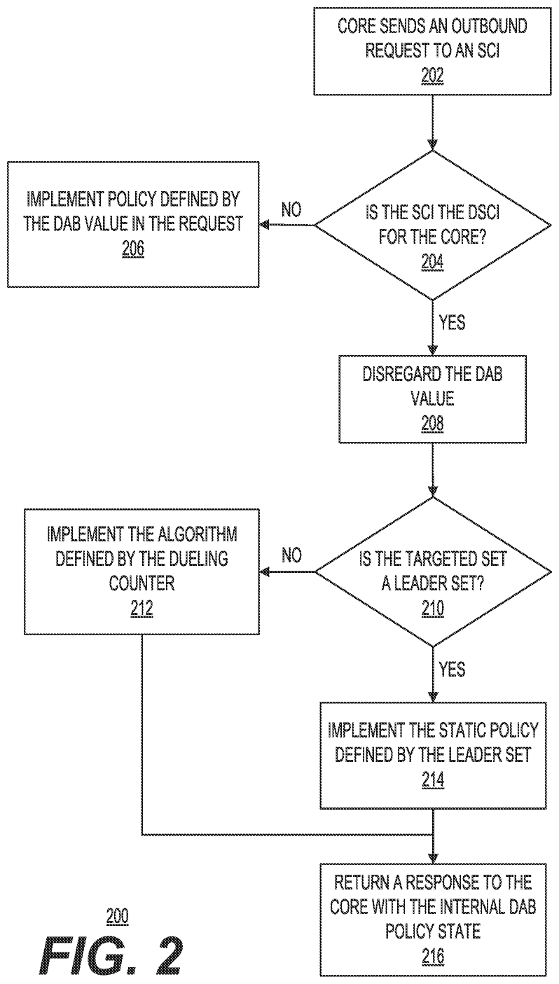

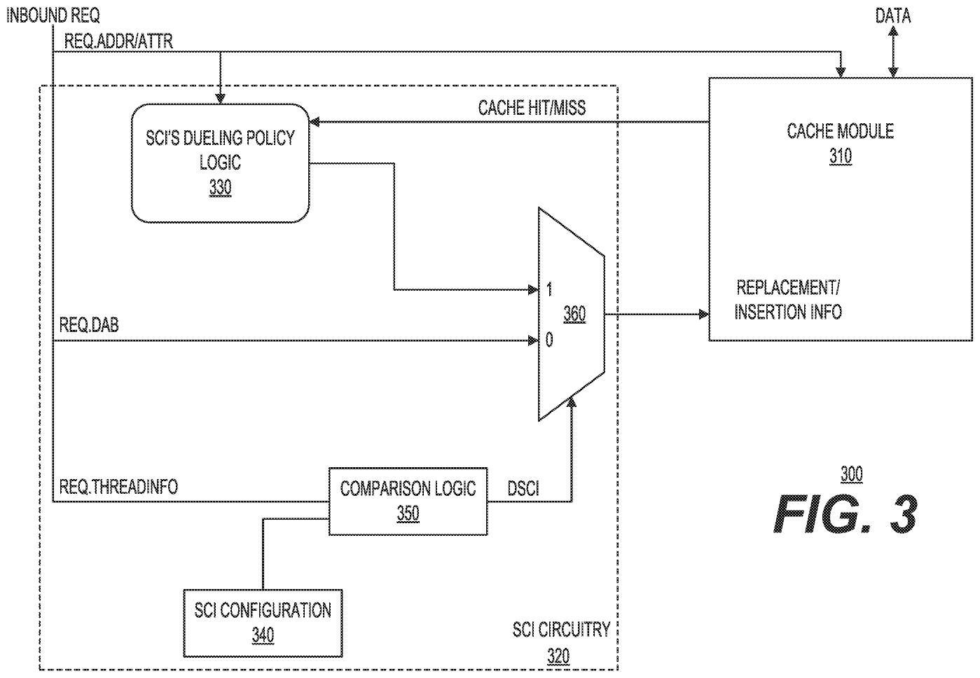

FIG. 2 shows a flow chart 200 for selecting a replacement policy for use with a thread as part of the implementation of effective set sampling and set-dueling in accordance with one example. As part of step 202, a core (e.g., core 1 102 of FIG. 1) sends an outbound request to an SCI (e.g., to SCI 0 142 of FIG. 1 or another SCI associated with SSLC 160 of FIG. 1). At step 204, the SCI circuitry (an example of such circuitry is described later with reference to FIG. 3) associated with the SCI that received the outbound request from the core determines whether this SCI is the delegated shared cache instance (DSCI) for the core that sent the outbound request. If the answer is no, then in step 206, the cache replacement policy defined by the DAB included as part of the outbound request from the core is implemented for any cache access requests for the thread (e.g., thread 0) that caused the core (e.g., core 0 102 of FIG. 1) to send the outbound request.

In one example, the DAB is included as part of the metadata portion of the outbound request. On the other hand, if the answer to the query in step 204 is yes, then in step 208, the DAB is disregarded. Outbound requests, inbound requests, and other messaging may be implemented using a cache protocol, such as the coherent hub interface (CHI) protocol offered by ARM. Other messaging protocols and associated functionality may also be used.

Next, in step 210, the SCI circuitry for the SCI that received the outbound request determines whether the targeted set is a leader set. If the answer is no, then in step 212, the replacement algorithm defined by the dueling counter is implemented for that SCI with respect to the outbound request sent by the core. On the other hand, if the answer is yes, then in step 214, the static policy defined by the leader set is implemented for that SCI. Finally, in step 216, the SCI circuitry sends to the core the response along with the internal DAB policy state. Although FIG. 2 shows certain steps being performed in a certain order as part of flow 200, additional or fewer steps in a different order may also be performed to achieve similar results.

FIG. 3 shows a shared cache instance 300 with example shared cache instance (SCI) circuitry 320 for implementing effective set sampling and set-dueling. In one example, SCI circuitry 320 may be used to implement the steps described earlier with respect to flow chart 200 of FIG. 2. In this example, shared cache instance (SCI) 300 also includes a cache module 310, which is used for storing cache lines, cache addresses, and other attributes/metadata associated with the shared cache instance 300. Certain bits from the inbound request (e.g., from a thread) for cache access are communicated to SCI circuitry 320. In this example, the inbound request message is in a packet form and includes a number of bits. In this example, those bits include bits labeled as: REQ.ADDR/ATTR, REQ.DAB, and REQ.THREADINFO in FIG. 3. The REQ.ADDR/ATTR bits include both the cache address and any attributes associated with the cache. In one example, the cache attributes include information, such as the size of each set in a shared cache instance, the nature of associativity, the number of sets in the shared cache instance, the number of set bits, the number of tag bits, and other relevant information, as needed. In this example, the REQ.DAB bit includes the dynamic algorithm bit, as described earlier with respect to FIGS. 1 and 2. In this example, the REQ. THREADINFO bits include at least the thread number (e.g., thread 0, thread 1, or thread N) for the thread that initiated the cache access request.

With continued reference to FIG. 3, SCI circuitry 320 includes SCI's set dueling policy logic 330, SCI configuration 340, comparison logic 350, and multiplexer 360. SCI's dueling policy logic 330 includes logic configured to implement set-dueling that makes two different replacement policies (e.g., ReplA and ReplB) compete against each other to identify the winner that provides the highest hit-rate (or equivalently, the lowest miss-rate). Cache module 310 provides cache hit/miss information to SCI's dueling policy logic 330. As explained earlier, a dueling counter may be used to implement set-dueling. SCI's dueling policy logic 300 includes logic that can process the output of a dueling counter (e.g., the most significant bit (MSB) associated with the counter) and based on a status of the counter, dynamically identify the winning policy. A miss in the leader sets of ReplA will decrement the dueling counter, while a miss in the leader sets of ReplB will increment the dueling counter. In this manner, the dueling counter measures the policy that generates the most misses, and thus the opposite replacement policy is chosen to maximize hits. The chosen replacement policy is provided as one of the inputs (input 1) to multiplexer 360.

Still referring to FIG. 3, the other input (input 0) to multiplexer 360 is used to receive the information carried as part of the REQ.DAB bit. SCI configuration 340 is configured as a register and it is used to store one of the thread numbers (e.g., thread 0) as a thread identifier (assuming SCI 300 is the delegated shared cache instance for thread 0). Comparison logic 350 is used to compare the stored value in SCI configuration 340 with the information in the REQ.THREADINFO bits. The output (labeled as DSCI in FIG. 3) of comparison logic 350 is used to control which input signal is provided as an output by multiplexer 360. As explained earlier with respect to step 204 of FIG. 2, if SCI 300 is the delegated shared cache instance (DSCI) for core 0 (thread 0 being mapped to core 0), then the bit included as part of REQ.DAB is disregarded. This is because in such an instance the output (DSCI) of comparison logic 350 is such that the signal received via input terminal 0 is disregarded. Instead, the signal received from SCI's dueling policy logic 330 is used to implement the cache replacement policy for SCI 300. As described herein, advantageously the proposed systems and methods require minimal additional hardware in the form of storage in the core (for the DAB), while reducing the amount of logic in the shared cache instances.

With respect to example SCI 300 of FIG. 3, the core needs to be able to store a single bit per thread to maintain and transmit the DAB. The SCI needs an additional bit per thread in the system (e.g., 63 additional bits for a 64-thread system), and the supporting logic shown in FIG. 3. The command and response messages need to transport an additional bit for the DAB as a part of the payload (e.g., the packet). Advantageously, the DSCI now requires less dueling hardware since there are fewer cumulative leader sets, potentially resulting in a reduced amount of dueling hardware. In the case of a system where there is an imbalanced number of physical cores and SCIs, the SCIs can be delegated to handle fewer/more threads for dueling. By analyzing the system further, the number of leader sets can be reduced if cores outnumber the SCIs (since more traffic from the thread would be concentrated per SCI).

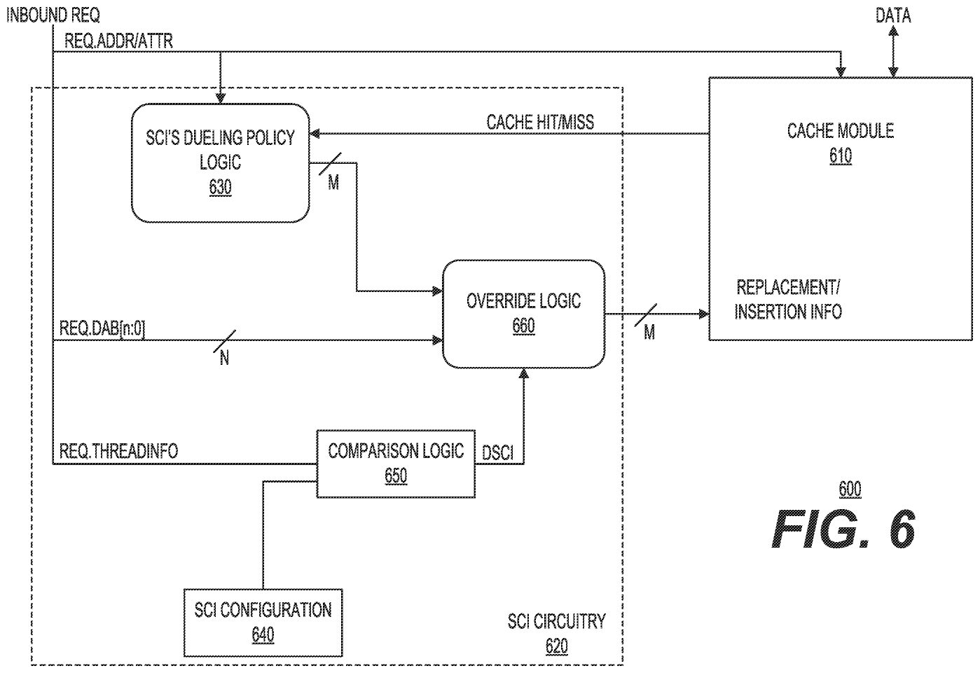

Although FIG. 3 shows SCI 300 as including certain components arranged in a certain way, SCI 300 may include additional or fewer components that are arranged differently. As an example, other logic, including finite state machines may be used to implement some of the functionality associated with SCI circuitry 320. As another example, FIG. 6 (described later) provides an alternative implementation of an SCI. In addition, although FIG. 3 describes SCI 300 in the context of cache replacement algorithms, SCI 300 can also be configured for use with other cache algorithms, including insertion algorithms and allocation algorithms. Moreover, when the shared cache instances outnumber the threads, or when higher accuracy from a larger number of the delegated shared cache instances is needed, a tie-breaker logic can be used to choose the winning algorithm. When a thread is paired to two delegated shared cache instances, either the latest DAB response can be used or the highest frequency winning algorithm can be identified using a history shift register. When a thread is paired to an odd number of shared cache instances, majority vote can be used. If a thread is paired to an even number of shared cache instances, majority vote can be used, and the tie can be broken using the most recent DAB response.

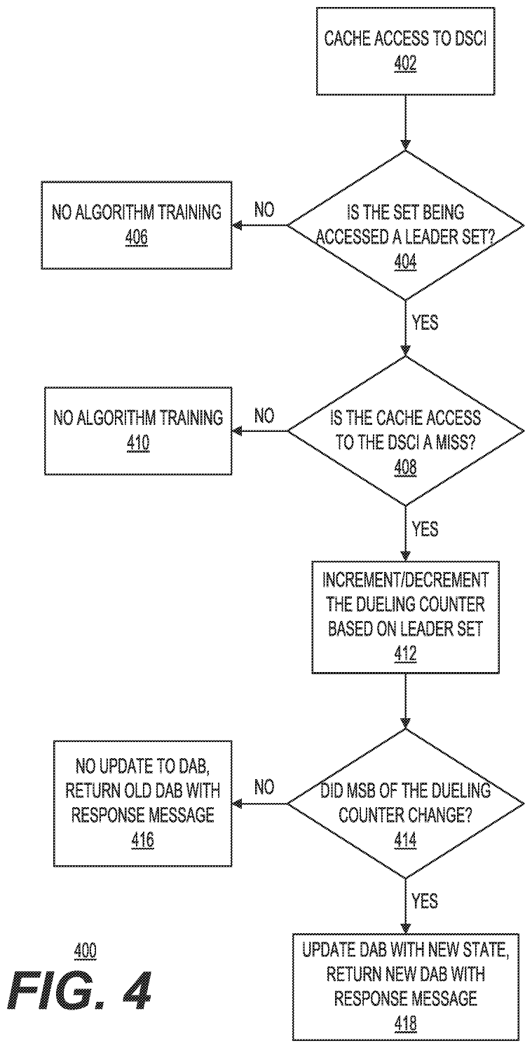

FIG. 4 shows a flow chart 400 for updating the dynamic algorithm bit (DAB) and training the set dueling counter as part of the implementation of effective set sampling and set-dueling. At step 402, a thread (e.g., thread 0) is shown as accessing a delegated shared cache instance (DSCI) for that thread, that being SCI 0. At step 404, the logic associated with the shared cache instance (e.g., SCI 0) determines whether the set being accessed is a leader set. If the answer is no, then no algorithm training is performed, as shown via block 406. This is because the dueling counter is not affected at all. If, however, the answer is yes, then in step 408 the logic associated with the SCI determines whether the cache access to the DSCI is a miss. If it is not a miss, then once again no algorithm training is performed, as shown via block 410. If, however, it is a cache miss, then in step 412 the dueling counter is incremented or decremented based on the leader set.

Next, in step 414, the logic associated with the SCI determines whether the most significant bit (MSB) of the dueling counter changed. If the answer is no, then there is no update to the DAB and as part of step 416, the old DAB value is returned to the thread via the response message. If, however, the answer is yes, then the DAB is updated with the new state and as part of step 418, the new DAB is returned to the thread via the response message. Although FIG. 4 shows certain steps being performed in a certain order as part of flow 400, additional or fewer steps in a different order may also be performed to achieve similar results

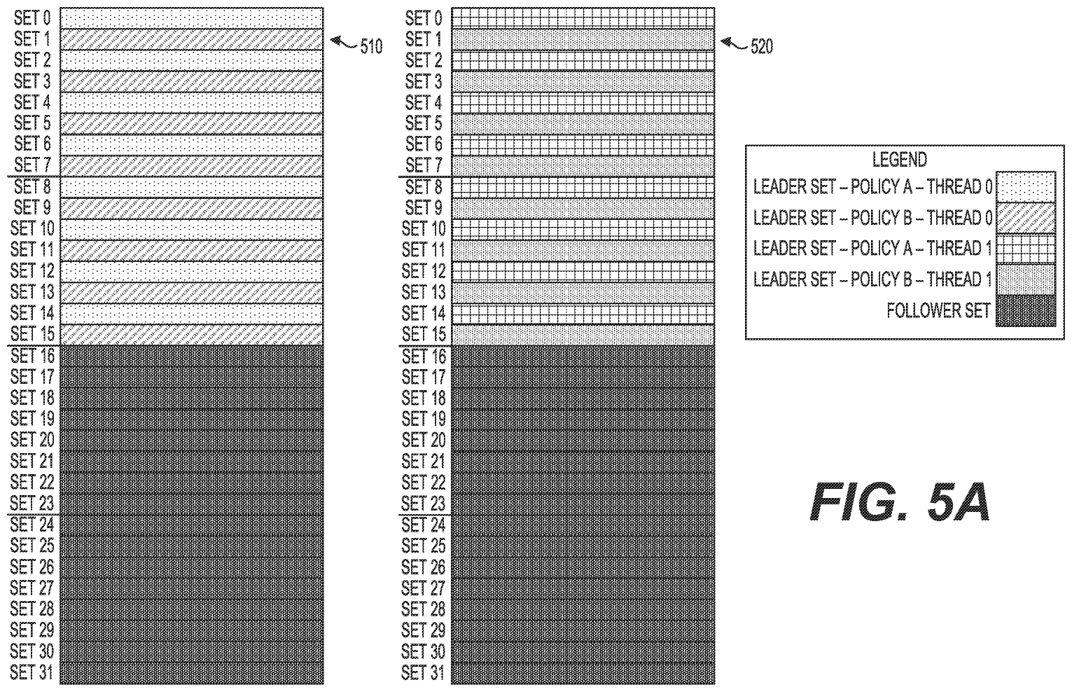

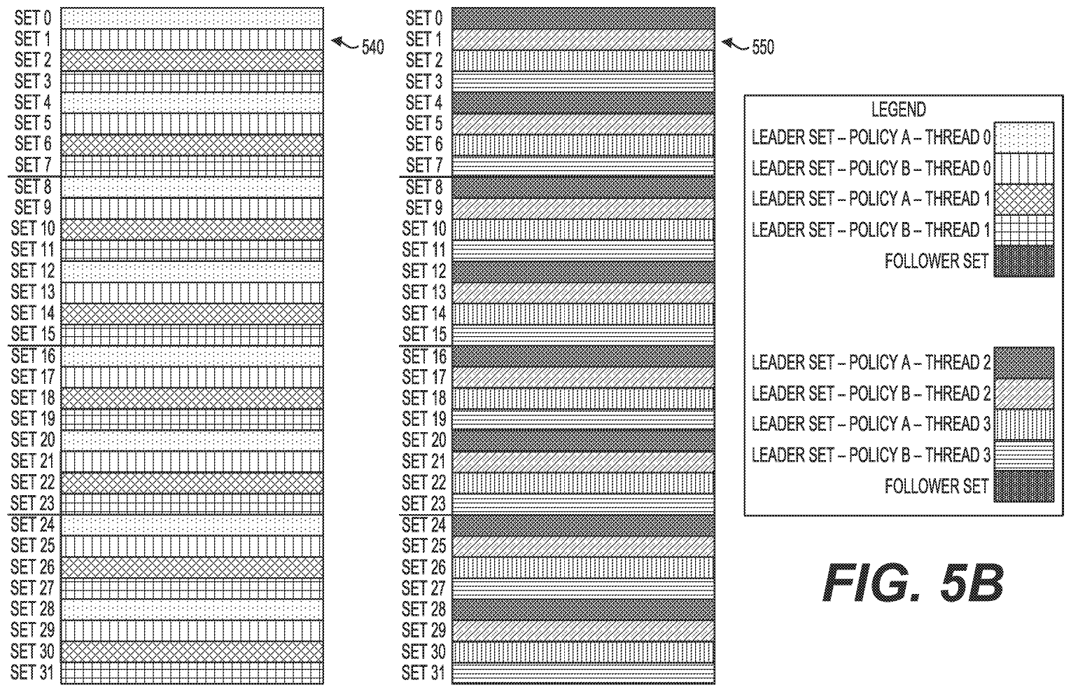

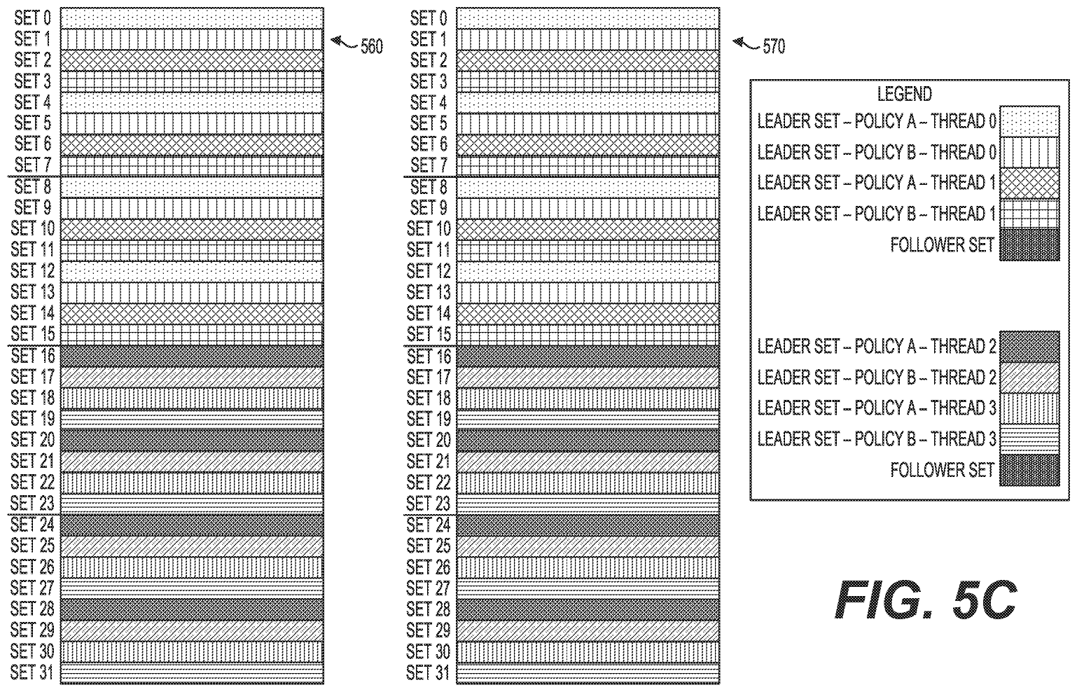

FIGS. 5A-C show three different examples of layouts of leader sets and follower sets from a thread's perspective for implementing effective set sampling and set-dueling. Assuming a system with 32 single-threaded cores and 32 SCIs, 32 threads need to be evaluated per SCI. Thus, in a conventional system, SCI 0 determines duel winners for threads 0, 1, 2, . . . 31; SCI 1 determines duel winners for threads 0, 1, 2, . . . 31; . . . and SCI 31 determines duel winners for threads 0, 1, 2, . . . 31. The problem with this approach is that there are a limited number of sets per SCI. In addition, it is difficult to scale to a higher core count. FIG. 5A shows an example of a layout of the sets from the perspective of two different threads (thread 0 and thread 1). The layouts described with respect to FIG. 5A delegate SCI 0 to determine the duel winner for thread 0 only and delegate SCI 1 to determine the duel winner for thread 1 only. Although not shown in FIG. 5A, other delegated SCIs can also be used to measure the duel winners in a similar manner as described earlier with respect to FIGS. 1-4.

Layout 510 corresponds to a layout of leader sets and follower sets for a delegated shared cache instance (e.g., SCI 0) from the perspective of thread 0. Layout 520 corresponds to a layout of leader sets and follower sets for a delegated shared cache instance (e.g., SCI 1) from the perspective of thread 1. The legend in FIG. 5A shows that there are leader sets for two different replacement policies (policy A and policy B) for thread 0. Similarly, as shown in the legend in FIG. 5A, there are leader sets for two different replacement policies (policy A and policy B) for thread 1. Policy A may be one of the dynamic replacement algorithms, such as dynamic re-reference interval prediction (DRRIP). Policy B may be another one of the dynamic replacement algorithms, such as dynamic re-reference interval prediction (DRRIP). Thus, policy A may be a static RRIP (SRRIP) policy that involves the use of fixed value for the re-reference interval across the shared cache instance. Policy B may be a bimodal RRIP (BRRIP) policy that inserts certain cache blocks with a distant re-reference interval prediction and inserts certain other cache blocks with a long re-reference interval prediction. The choice between the two could be made probabilistically, such that one of the two is chosen less frequently than the other one.

As shown in layout 510, from thread 0's perspective, any time there is an access to set 0, set 2, set 4, set 6, set 8, set 10, set 12, or set 14, the cache replacement algorithm per policy A will be used. From thread 0's perspective, any time there is an access to set 1, set 3, set 5, set 7, set 9, set 11, set 13, or set 15, the cache replacement algorithm per policy B will be used. Any access to sets 16 to 32 (the follower sets in this example) would result in the implementation of the cache replacement policy determined by the dueling counter. As shown in layout 520, from thread 1's perspective, any time there is an access to set 0, set 2, set 4, set 6, set 8, set 10, set 12, or set 14, the cache replacement algorithm per policy A will be used. From thread 1's perspective, any time there is an access to set 1, set 3, set 5, set 7, set 9, set 11, set 13, or set 15, the cache replacement algorithm per policy B will be used. Any access to sets 16 to 32 (the follower sets in this example) would result in the implementation of the cache replacement policy determined by the dueling counter. The winning cache replacement policy is sent as part of the DAB included in the command messages to the shared cache instances. As explained earlier, when core0/thread0 accesses SCI 0, the winning policy bit (DAB) is collected and stored. Similarly, when core0/thread0 accesses a different SCI, the DAB with the winning policy information is sent to that SCI to implement it.

FIG. 5B shows an example of a layout of the sets from the perspective of four different threads (thread 0, thread 1, thread 2, and thread 3). This example relates to multiple threads per delegated shared cache instance (DSCI). Each thread has its own dueling counter. Layout 540 corresponds to a layout of leader sets and follower sets (not shown) for a delegated shared cache instance (e.g., SCI 0) from the perspective of threads 0 and 1. Layout 550 corresponds to a layout of leader sets and follower sets (not shown) for a delegated shared cache instance (e.g., SCI 1) from the perspective of threads 2 and 3. The legend in FIG. 5B shows that there are leader sets for two different replacement policies (policy A and policy B) for thread 0. Similarly, as shown in the legend in FIG. 5B, there are leader sets for two different replacement policies (policy A and policy B) for thread 1. In a similar fashion, as shown in the legend in FIG. 5B, there are leader sets for two different replacement policies (policy A and policy B) for thread 2. Likewise, there are leader sets for two different replacement policies (policy A and policy B) for thread 3.

As before, policy A may be one of the dynamic replacement algorithms, such as dynamic re-reference interval prediction (DRRIP). Policy B may be another one of the dynamic replacement algorithms, such as dynamic re-reference interval prediction (DRRIP). Thus, policy A may be a static RRIP (SRRIP) policy that involves the use of fixed value for the re-reference interval across the shared cache instance. Policy B may be a bimodal RRIP (BRRIP) policy that inserts certain cache blocks with a distant re-reference interval prediction and inserts certain other cache blocks with a long re-reference interval prediction. The choice between the two could be made probabilistically, such that one of the two is chosen less frequently than the other one.

As shown in layout 540, from thread 0's perspective, any time there is an access to set 0, set 4, set 8, set 12, set 16, set 20, set 24, or set 28 of SCI 0, the cache replacement algorithm per policy A will be used. From thread 0's perspective, any time there is an access to set 1, set 5, set 9, set 13, set 17, set 21, set 25, or set 29 of SCI 0, the cache replacement algorithm per policy B will be used. As shown in layout 540, from thread 1's perspective, any time there is an access to set 2, set 6, set 10, set 14, set 18, set 23, set 26, or set 30 of SCI 0, the cache replacement algorithm per policy A will be used. From thread 1's perspective, any time there is an access to set 3, set 7, set 11, set 15, set 19, set 23, set 27, or set 31 of SCI 0, the cache replacement algorithm per policy B will be used. Any access to the sets beyond (the follower sets in this example) would result in the implementation of the cache replacement policy determined by a respective dueling counter. Since there is a dueling counter per thread, in this example two dueling counters (one for thread 0 and another for thread 1) are being used.

As shown in layout 550, from thread 2's perspective, any time there is an access to set 0, set 4, set 8, set 12, set 16, set 20, set 24, or set 28 of SCI 1, the cache replacement algorithm per policy A will be used. From thread 2's perspective, any time there is an access to set 1, set 5, set 9, set 13, set 17, set 21, set 25, or set 29 of SCI 1, the cache replacement algorithm per policy B will be used. As shown in layout 550, from thread 3's perspective, any time there is an access to set 2, set 6, set 10, set 14, set 18, set 23, set 26, or set 30 of SCI 1, the cache replacement algorithm per policy A will be used. From thread 3's perspective, any time there is an access to set 3, set 7, set 11, set 15, set 19, set 23, set 27, or set 31 of SCI 1, the cache replacement algorithm per policy B will be used. Any access to the sets beyond set 31 (the follower sets in this example) would result in the implementation of the cache replacement policy determined by a respective dueling counter. Since there is a dueling counter per thread, in this example two dueling counters (one for thread 2 and another for thread 3) are being used. The winning cache replacement policy is sent as part of the DAB included in the command messages to the shared cache instances. As explained earlier, when core0/thread0 accesses SCI 0, the winning policy bit (DAB) is collected and stored. Similarly, when core0/thread0 accesses a different SCI, the DAB with the winning policy information is sent to that SCI to implement it.

FIG. 5C shows an example of a layout of the sets from the perspective of four different threads (thread 0, thread 1, thread 2, and thread 3). This example relates to multiple threads per delegated shared cache instance (DSCI) that are further distributed across the two different DSCIs. Each thread has its own dueling counter. Layout 560 corresponds to a layout of leader sets and follower sets (not shown) for a delegated shared cache instance (e.g., SCI 0) from the perspective of threads 0, 1, 2, and 3. Layout 570 corresponds to a layout of leader sets and follower sets (not shown) for a delegated shared cache instance (e.g., SCI 1) from the perspective of threads 0, 1, 2, and 3. The legend in FIG. 5C shows that there are leader sets for two different replacement policies (policy A and policy B) for thread 0. Similarly, as shown in the legend in FIG. 5C, there are leader sets for two different replacement policies (policy A and policy B) for thread 1. In a similar fashion, as shown in the legend in FIG. 5C, there are leader sets for two different replacement policies (policy A and policy B) for thread 2. Likewise, there are leader sets for two different replacement policies (policy A and policy B) for thread 3.

As before, policy A may be one of the dynamic replacement algorithms, such as dynamic re-reference interval prediction (DRRIP). Policy B may be another one of the dynamic replacement algorithms, such as dynamic re-reference interval prediction (DRRIP). Thus, policy A may be a static RRIP (SRRIP) policy that involves the use of fixed value for the re-reference interval across the shared cache instance. Policy B may be a bimodal RRIP (BRRIP) policy that inserts certain cache blocks with a distant re-reference interval prediction and inserts certain other cache blocks with a long re-reference interval prediction. The choice between the two could be made probabilistically, such that one of the two is chosen less frequently than the other one.

As shown in layouts 560 and 570, from thread 0's perspective, any time there is an access to set 0, set 4, set 8, or set 12 of SCI 0 or SCI 1, the cache replacement algorithm per policy A will be used. From thread 0's perspective, any time there is an access to set 1, set 5, set 9, or set 13 of SCI 0 or SCI 1, the cache replacement algorithm per policy B will be used. As shown in layouts 560 and 570, from thread 1's perspective, any time there is an access to set 2, set 6, set 10, or set 14 of SCI 0 of SCI 1, the cache replacement algorithm per policy A will be used. From thread 1's perspective, any time there is an access to set 3, set 7, set 11, or set 15 of SCI 0 or SCI 1, the cache replacement algorithm per policy B will be used. Any access to the sets beyond set 31 (the follower sets in this example, which are not shown) would result in the implementation of the cache replacement policy determined by a respective dueling counter. Since there is a dueling counter per thread, in this example four dueling counters (one for thread 0, one for thread 1, one for thread 2, and one for thread 3) are being used.

As shown in layouts 560 and 570, from thread 2's perspective, any time there is an access to set 16, set 20, set 24, or set 28 of SCI 0 or SCI 1, the cache replacement algorithm per policy A will be used. From thread 2's perspective, any time there is an access to set 17, set 21, set 25, or set 29 of SCI 0 or SCI 1, the cache replacement algorithm per policy B will be used. As shown in layouts 560 and 570, from thread 3's perspective, any time there is an access to set 18, set 22, set 26, or set 30 of SCI 0 of SCI 1, the cache replacement algorithm per policy A will be used. From thread 3's perspective, any time there is an access to set 19, set 23, set 27, or set 31 of SCI 0 or SCI 1, the cache replacement algorithm per policy B will be used. Any access to the sets beyond set 31 (the follower sets in this example, which are not shown) would result in the implementation of the cache replacement policy determined by a respective dueling counter. Since there is a dueling counter per thread, in this example four dueling counters (one for thread 0, one for thread 1, one for thread 2, and one for thread 3) are being used. The winning cache replacement policy is sent as part of the DAB included in the command messages to the shared cache instances. As explained earlier, when core0/thread0 accesses SCI 0 or SCI 1, the winning policy bit (DAB) is collected and stored. Similarly, when core0/thread0 accesses a different SCI, the DAB with the winning policy information is sent to that SCI to implement it.

FIG. 6 shows another example shared cache instance (SCI) circuitry 600 for implementing effective set sampling and set-dueling. In one example, SCI circuitry 620, included in SCI 600, may be used to not only implement the steps described earlier with respect to flow chart 200 of FIG. 2 but also provide additional functionality for the system. As an example, the dynamic algorithm bit (DAB) in this example is not just a single bit of information but is multi-bit (e.g., N bits) information. Thus, the policy information for implementing a particular cache algorithm can include additional information than just the single bit information described earlier with respect to FIG. 3. A plurality of dynamic algorithm bits (DABs) can include policy information obtained from other shared cache instances and can then be used to augment or override the policy information for that SCI. In this example, similar to SCI 300 of FIG. 3, shared cache instance (SCI) 600 includes a cache module 610, which is used for storing cache lines, cache addresses, and other attributes/metadata associated with the shared cache instance 600. Certain bits from the inbound request (e.g., from a thread) for cache access are communicated to SCI circuitry 620.

In this example, the inbound request message is also in a packet form and includes a number of bits. Those bits include bits labeled as: REQ.ADDR/ATTR, REQ. DAB [N:0], and REQ. THREADINFO in FIG. 6. In this example, the REQ.ADDR/ATTR bits include both the cache address and any attributes associated with the cache. In one example, the cache attributes include information, such as the size of each set in a shared cache instance, the nature of associativity, the number of sets in the shared cache instance, the number of set bits, the number of tag bits, and other relevant information, as needed. In this example, the REQ.DAB [N:0] bits include the dynamic algorithm bits. As noted above, dynamic algorithm bits (DABs) can include policy information obtained from other shared cache instances and can then be used to augment or override the policy information for that SCI. In this example, the REQ.THREADINFO bits include at least the thread number (e.g., thread 0, thread 1, or thread K) for the thread that initiated the cache access request.

With continued reference to FIG. 6, SCI circuitry 620 includes SCI's set dueling policy logic 630, SCI configuration 640, comparison logic 650, and override logic 660. SCI's dueling policy logic 630 includes logic configured to implement set-dueling that makes two different cache algorithms (e.g., replacement policies (e.g., ReplA and ReplB)) compete against each other to identify the winner that provides the highest hit-rate (or equivalently, the lowest miss-rate). Cache module 610 provides cache hit/miss information to SCI's dueling policy logic 630. As explained earlier, a dueling counter may be used to implement set-dueling. SCI's dueling policy logic 600 includes logic that can process the output of a dueling counter (e.g., the most significant bit (MSB) associated with the counter) and based at least on a status of the counter, dynamically identify the winning policy. A miss in the leader sets of ReplA will decrement the dueling counter, while a miss in the leader sets of ReplB will increment the dueling counter. In this manner, the dueling counter measures the policy that generates the most misses, and thus the opposite replacement policy is chosen to maximize hits. The chosen replacement policy is provided as one of the inputs to override logic 660.

Still referring to FIG. 6, override logic 660 is also provided the policy information carried as part of the REQ.DAB [N:0] bits. SCI configuration 640 is configured as a register and it is used to store one of the thread numbers (e.g., thread 0) assuming SCI 600 is a delegated shared cache instance for thread 0. Comparison logic 650 is used to compare the stored value in SCI configuration 640 with the information in the REQ.THREADINFO bits. The output (labeled as DSCI) of comparison logic 650 is provided as one of the control inputs to override logic 660. As explained earlier with respect to step 204 of FIG. 2, if SCI 600 is the delegated shared cache instance (DSCI (e.g., as indicated by the DSCI control signal show in FIG. 6)) for core 0 (thread 0 being mapped to core 0), then the bits included as part of REQ.DAB [N:0] may be disregarded. Instead, the M bits of information received from SCI's dueling policy logic 630 is used to implement the cache replacement policy for SCI 600. Although FIG. 6 shows SCI 600 as including certain components arranged in a certain way, SCI 600 may include additional or fewer components that are arranged differently. As an example, other logic, including finite state machines may be used to implement some of the functionality associated with SCI circuitry 620. In addition, although FIG. 6 describes SCI 600 in the context of cache replacement algorithms, SCI 600 can also be configured for use with other cache algorithms, including insertion algorithms and allocation algorithms.

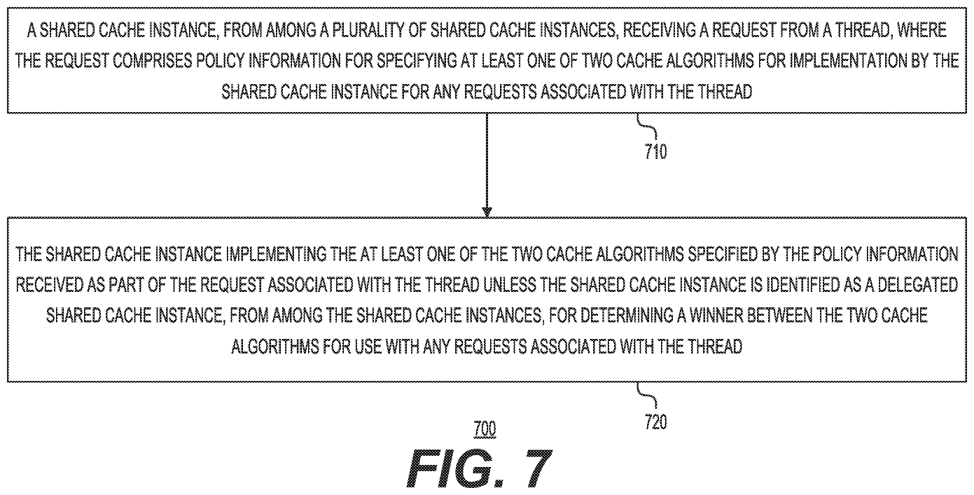

FIG. 7 shows a flow chart 700 of an example method for selecting a cache algorithm based on effective set sampling and set-dueling. In one example, this method relates to selecting a cache algorithm in a system having a plurality of cores and a plurality of shared cache instances accessible to any of the plurality of cores, where the system is configurable to execute multiple threads. In one example, the steps associated with this method may be executed by various components of the systems described earlier (e.g., system 100 of FIG. 1, SCI 300 of FIG. 3 and/or SCI 600 of FIG. 6). Step 710 includes a shared cache instance, from among the plurality of shared cache instances, receiving a request associated with a thread, where the request comprises policy information for specifying at least one of two cache algorithms for implementation by the shared cache instance for any requests associated with the thread. As explained earlier, the request for cache access may be received by any of the shared cache instances, including the delegated shared cache instances described earlier. As an example, FIG. 2 shows in step 202 the core sending an outbound request to a shared cache instance. The policy information included as part of the request may include the DAB bit or the DAB [N:0] bits. Further details regarding the function of the policy information and its processing in the context of the systems described herein are provided earlier with respect to FIGS. 1-6.

Step 720 includes the shared cache instance implementing the at least one of the two cache algorithms specified by the policy information received as part of the request associated with the thread unless the shared cache instance is identified as a delegated shared cache instance, from among the shared cache instances, for determining a winner between the at least two cache algorithms for use with any requests associated with the thread. As an example, as described with respect to FIG. 2, at step 204, the SCI circuitry (e.g., SCI circuitry 320 of FIG. 3 or SCI circuitry 620 of FIG. 6) associated with the SCI that received the outbound request from the core determines whether this SCI is the delegated shared cache instance (DSCI) for the core that sent the outbound request. If the answer is no, then as shown with respect to the example in step 206 of FIG. 2, the cache replacement policy defined by the DAB included as part of the outbound request from the core is implemented for any cache access requests for the thread (e.g., thread 0) that caused the core (e.g., core 0 102 of FIG. 1) to send the outbound request. The policy information included as part of the request may include the DAB bit or the DAB [N:0] bits. In one example, the DAB is included as part of the metadata portion of the outbound request. On the other hand, if the answer to the query in step 204 of FIG. 2 is yes, then in step 208 of FIG. 2, the DAB is disregarded. Further details regarding the function of the policy information and its processing in the context of the systems described herein are provided earlier with respect to FIGS. 1-6.

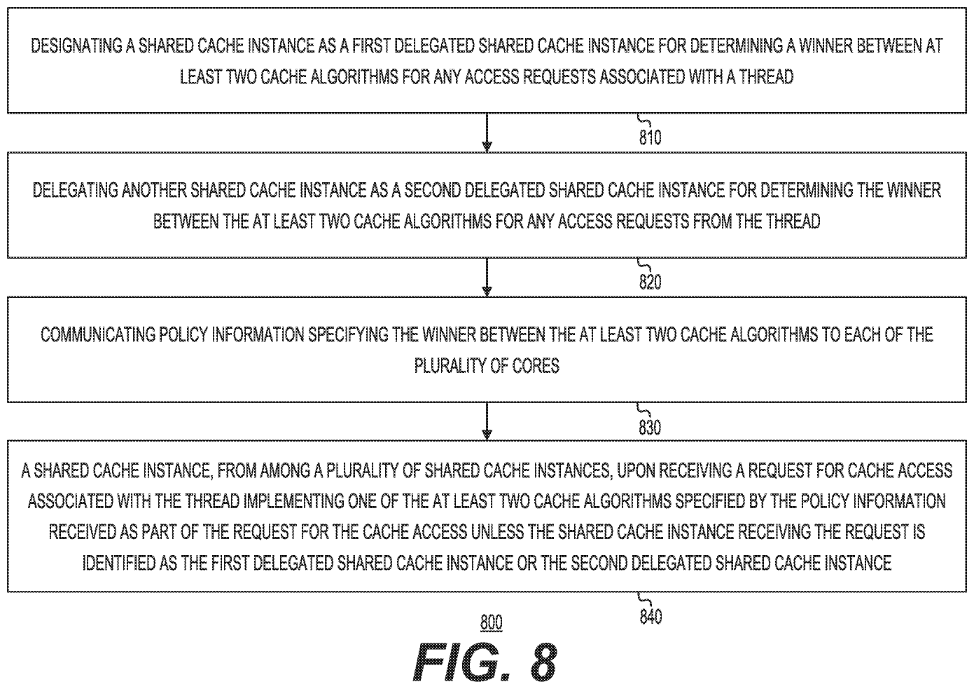

FIG. 8 shows a flow chart 800 of another example method for selecting a cache algorithm based on effective set sampling and set-dueling. In one example, this method relates to selecting a cache algorithm in a system having a plurality of cores and a plurality of shared cache instances accessible to any of the plurality of cores, where the system is configurable to execute multiple threads. In one example, the steps associated with this method may be executed by various components of the systems described earlier (e.g., system 100 of FIG. 1, SCI 300 of FIG. 3 and/or SCI 600 of FIG. 6). Step 810 includes designating a shared cache instance as a first delegated shared cache instance for determining a winner between at least two cache algorithms for any access requests associated with a thread. In one example, the winner is determined using a first set-dueling counter associated with the first delegated shared cache instance. As explained earlier, the set-dueling counter is incremented or decremented if the request associated with the thread is accessing a leader set for the delegated shared cache instance and the request results in a cache miss. As an example, steps 404, 408, and 412 described earlier with respect to FIG. 4 provide additional details for determining the winner by using a delegated shared cache instance. The set-dueling counter may be incremented or decremented based on a cache miss determination or a cache hit determination. As an example, upon determination of a cache miss one can increment the set-dueling counter on a miss to a leader set for policy A and decrement the set-dueling counter on a miss to a leader set for policy B. If the set-dueling counter has a value of less than half the counter value, then policy B is resulting in more misses than policy A. Thus, in this case, policy A is chosen. As another example, upon determination of a cache hit one can increment the set-dueling counter on a hit to a leader set for policy A and decrement the set-dueling counter on a hit to a leader set for policy B. If the set-dueling counter has a value of less than half the counter value, then policy B is resulting in more hits (fewer misses) than policy A. Thus, in this case, policy B is chosen.

Step 820 includes delegating another shared cache instance as a second delegated shared cache instance for determining the winner between the at least two cache algorithms for any access requests associated with the thread. In one example, the winner is determined using a second set-dueling counter associated with the second delegated shared cache instance. As explained earlier, the set-dueling counter is incremented or decremented if the request associated with the thread is accessing a leader set for the delegated shared cache instance and the request results in a cache miss. As an example, steps 404, 408, and 412 described earlier with respect to FIG. 4 provide additional details for determining the winner by using a delegated shared cache instance.

Step 830 includes communicating policy information specifying the winner between the at least two cache algorithms to each of the plurality of cores. In one example, as described earlier with respect to FIG. 1, interconnect 110 of FIG. 1 includes several switches (e.g., switches 112, 114, 116, 118, 120, 122, 124, 126, 128, and 130) allowing for the exchange of both commands (e.g., read access or write access commands) and data among the cores and the shared cache instances included as part of SSLC 160 of FIG. 1. As described earlier, SSLC 160 of FIG. 1 includes several shared cache instances, including delegated shared cache instances (DSCIs).

Step 840 includes a shared cache instance, from among the plurality of shared cache instances, upon receiving a request for cache access associated with the thread implementing one of the at least two cache algorithms specified by the policy information received as part of the request for the cache access unless the shared cache instance receiving the request is identified as the first delegated shared cache instance or the second delegated shared cache instance. As an example, as described with respect to FIG. 2, at step 204, the SCI circuitry (e.g., SCI circuitry 320 of FIG. 3 or SCI circuitry 620 of FIG. 6) associated with any of the SCIs that received the outbound request from the core determines whether this SCI is the delegated shared cache instance (DSCI) for the core that sent the outbound request. If the answer is no, then as shown with respect to the example in step 206 of FIG. 2, the cache replacement policy defined by the DAB included as part of the outbound request from the core is implemented for any cache access requests for the thread (e.g., thread 0) that caused the core (e.g., core 0 102 of FIG. 1) to send the outbound request. The policy information included as part of the request may include the DAB bit or the DAB [N:0] bits. In one example, the DAB is included as part of the metadata portion of the outbound request. On the other hand, if the answer to the query in step 204 of FIG. 2 is yes, then in step 208 of FIG. 2, the DAB is disregarded. Further details regarding the function of the policy information and its processing in the context of the systems described herein are provided earlier with respect to FIGS. 1-6.

In conclusion, the present disclosure relates to a method for selecting a cache algorithm in a system having a plurality of cores and a plurality of shared cache instances accessible to any of the plurality of cores, where the system is configurable to execute threads. The method may include a shared cache instance, from among the plurality of shared cache instances, receiving a request associated with a thread, where the request comprises policy information for specifying at least one of two cache algorithms for implementation by the shared cache instance for any requests associated with the thread.

The method may further include the shared cache instance implementing the at least one of the two cache algorithms specified by the policy information received as part of the request associated with the thread unless the shared cache instance is identified as a delegated shared cache instance, from among the shared cache instances, for determining a winner between the two cache algorithms for use with any requests associated with the thread.

The method may further comprise disregarding the policy information when the shared cache instance is identified as the delegated shared cache instance. The method may further comprise implementing the winner between the at least two cache algorithms for the delegated shared cache instance if the request associated with the thread is not accessing a leader set.

The method may further comprise implementing a policy specified by leader sets for the delegated shared cache instance if the request associated with the thread is accessing a leader set. The winner is determined using a set-dueling counter, and the method may further comprise based on one of a cache hit determination or a cache miss determination incrementing or decrementing the set-dueling counter if the request associated with the thread is accessing a leader set.

The method may further comprise updating the policy information received as part of the request associated with the thread if the set-dueling counter reaches a predetermined state. The method may further comprise returning as part of a response message from the shared cache instance updated policy information to each of the plurality of cores to ensure any future requests from the thread comprises the updated policy information for specifying the at least one of the two cache algorithms for implementation by the shared cache instance.

In another example, the present disclosure relates to a system having a plurality of cores and a plurality of shared cache instances accessible to any of the plurality of cores, where the system is configurable to execute threads. The system may include a shared cache instance, from among the plurality of shared cache instances, to receive a request associated with a thread, where the request comprises policy information for specifying at least one of two cache algorithms for implementation by the shared cache instance for any requests associated with the thread.

The system may further include shared cache instance circuitry, associated with the shared cache instance, configured to process the policy information received as part of the request associated with the thread. The shared cache instance circuitry may further be configured to instruct the shared cache instance to implement the at least one of the two cache algorithms unless the shared cache instance is identified by the shared cache instance circuitry as a delegated shared cache instance, from among the shared cache instances, for determining a winner between the at least two cache algorithms for use with any requests associated with the thread.

The system may further be configured to disregard the policy information when the shared cache instance is identified as the delegated shared cache instance. The system may further be configured to implement the winner between the two cache algorithms for the delegated shared cache instance if the request associated with the thread is not accessing a leader set.

The system may further be configured to implement a policy specified by leader sets for the delegated shared cache instance if the request associated with the thread is accessing a leader set. The winner is determined using a set-dueling counter, and the system may further be configured to, based on one of a cache hit determination or a cache miss determination, increment or decrement the set-dueling counter if the request associated with the thread is accessing a leader set.

The system may further be configured to update the policy information received as part of the request associated with the thread if the set-dueling counter reaches a predetermined state. The system may further be configured to return as part of a response message from the shared cache instance updated policy information to each of the plurality of cores to ensure any future requests associated with the thread comprises the updated policy information for specifying the at least one of the two cache algorithms for implementation by the shared cache instance.

In yet another example, the present disclosure relates to a method for selecting a cache algorithm in a system having a plurality of cores and a plurality of shared cache instances accessible to any of the plurality of cores, where the system is configurable to execute threads. The method may include designating a shared cache instance as a first delegated shared cache instance for determining a winner between at least two cache algorithms for access requests associated with a thread. The method may further include delegating another shared cache instance as a second delegated shared cache instance for determining the winner between the at least two cache algorithms for access requests associated with the thread.

The method may further include communicating policy information specifying the winner between the at least two cache algorithms to each of the plurality of cores. The method may further include a shared cache instance, from among the plurality of shared cache instances, upon receiving a request for cache access associated with the thread implementing one of the at least two cache algorithms specified by the policy information received as part of the request for the cache access unless the shared cache instance receiving the request is identified as the first delegated shared cache instance or the second delegated shared cache instance.

The winner is determined using a first set-dueling counter associated with the first delegated shared cache instance or using a second set-dueling counter associated with the second delegated shared cache instance. The winner is determined using a first set-dueling counter associated with the first delegated shared cache instance, and the method may further comprise based on one of a cache hit determination or a cache miss determination incrementing or decrementing the first set-dueling counter if the request associated with the thread is accessing a leader set for the first delegated shared cache instance.

The method may further comprise implementing a policy specified by leader sets for the first delegated shared cache instance if the request associated with the thread is accessing a leader set. The winner is determined using a second set-dueling counter associated with the second delegated shared cache instance, and the method may further comprise based on one of a cache hit determination or a cache miss determination incrementing or decrementing the second set-dueling counter if the request associated with the thread is accessing a leader set for the second delegated shared cache instance. The method may further comprise implementing a policy specified by leader sets for the second delegated shared cache instance if the request associated with the thread is accessing a leader set.

It is to be understood that the methods, modules, and components depicted herein are merely exemplary. Alternatively, or in addition, the functionality described herein can be performed, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-a-Chip systems (SOCs), and Complex Programmable Logic Devices (CPLDs). In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or inter-medial components. Likewise, any two components so associated can also be viewed as being “operably connected,” or “coupled,” to each other to achieve the desired functionality. Merely because a component, which may be an apparatus, a structure, a system, or any other implementation of a functionality, is described herein as being coupled to another component does not mean that the components are necessarily separate components. As an example, a component A described as being coupled to another component B may be a sub-component of the component B, the component B may be a sub-component of the component A, or components A and B may be a combined sub-component of another component C.

The functionality associated with some examples described in this disclosure can also include instructions stored in a non-transitory media. The term “non-transitory media” as used herein refers to any media storing data and/or instructions that cause a machine to operate in a specific manner. Exemplary non-transitory media include non-volatile media and/or volatile media. Non-volatile media include, for example, a hard disk, a solid-state drive, a magnetic disk or tape, an optical disk or tape, a flash memory, an EPROM, NVRAM, PRAM, or other such media, or networked versions of such media. Volatile media include, for example, dynamic memory such as DRAM, SRAM, a cache, or other such media. Non-transitory media is distinct from, but can be used in conjunction with transmission media. Transmission media is used for transferring data and/or instruction to or from a machine. Exemplary transmission media include coaxial cables, fiber-optic cables, copper wires, and wireless media, such as radio waves.

Furthermore, those skilled in the art will recognize that boundaries between the functionality of the above described operations are merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Although the disclosure provides specific examples, various modifications and changes can be made without departing from the scope of the disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to a specific example are not intended to be construed as a critical, required, or essential feature or element of any or all the claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed:

1. A method for selecting a cache algorithm in a system having a plurality of cores and a plurality of shared cache instances accessible to any of the plurality of cores, wherein the system is configurable to execute threads, the method comprising:
a shared cache instance, from among the plurality of shared cache instances, receiving a request associated with a thread, wherein the request comprises policy information for specifying at least one of two cache algorithms for implementation by the shared cache instance for any requests associated with the thread; and
the shared cache instance implementing the at least one of the two cache algorithms specified by the policy information received as part of the request associated with the thread unless the shared cache instance is identified as a delegated shared cache instance, from among the shared cache instances, for determining a winner between the two cache algorithms for use with any requests associated with the thread.

2. The method of claim 1, further comprising disregarding the policy information when the shared cache instance is identified as the delegated shared cache instance.

3. The method of claim 2, further comprising implementing the winner between the at least two cache algorithms for the delegated shared cache instance if the request associated with the thread is not accessing a leader set.

4. The method of claim 2, further comprising implementing a policy specified by leader sets for the delegated shared cache instance if the request associated with the thread is accessing a leader set.

5. The method of claim 1, wherein the winner is determined using a set-dueling counter, and the method further comprising based on one of a cache hit determination or a cache miss determination incrementing or decrementing the set-dueling counter if the request associated with the thread is accessing a leader set.

6. The method of claim 5, further comprising updating the policy information received as part of the request associated with the thread if the set-dueling counter reaches a predetermined state.

7. The method of claim 6, further comprising returning as part of a response message from the shared cache instance updated policy information to each of the plurality of cores to ensure any future requests from the thread comprises the updated policy information for specifying the at least one of the two cache algorithms for implementation by the shared cache instance.

8. A system having a plurality of cores and a plurality of shared cache instances accessible to any of the plurality of cores, wherein the system is configurable to execute threads, the system further comprising:
a shared cache instance, from among the plurality of shared cache instances, to receive a request associated with a thread, wherein the request comprises policy information for specifying at least one of two cache algorithms for implementation by the shared cache instance for any requests associated with the thread; and
shared cache instance circuitry, associated with the shared cache instance, configured to: (1) process the policy information received as part of the request associated with the thread and (2) instruct the shared cache instance to implement the at least one of the two cache algorithms unless the shared cache instance is identified by the shared cache instance circuitry as a delegated shared cache instance, from among the shared cache instances, for determining a winner between the two cache algorithms for use with any requests associated with the thread.

9. The system of claim 8, further configured to disregard the policy information when the shared cache instance is identified as the delegated shared cache instance.

10. The system of claim 9, further configured to implement the winner between the two cache algorithms for the delegated shared cache instance if the request associated with the thread is not accessing a leader set.

11. The system of claim 9, further configured to implement a policy specified by leader sets for the delegated shared cache instance if the request associated with the thread is accessing a leader set.

12. The system of claim 8, wherein the winner is determined using a set-dueling counter, and the system is further configured to, based on one of a cache hit determination or a cache miss determination, increment or decrement the set-dueling counter if the request associated with the thread is accessing a leader set.

13. The system of claim 12, further configured to update the policy information received as part of the request associated with the thread if the set-dueling counter reaches a predetermined state.

14. The system of claim 13, further configured to return as part of a response message from the shared cache instance updated policy information to each of the plurality of cores to ensure any future requests associated with the thread comprises the updated policy information for specifying the at least one of the two cache algorithms for implementation by the shared cache instance.

15. A method for selecting a cache algorithm in a system having a plurality of cores and a plurality of shared cache instances accessible to any of the plurality of cores, wherein the system is configurable to execute threads, the method comprising:
designating a shared cache instance as a first delegated shared cache instance for determining a winner between at least two cache algorithms for any access requests associated with a thread;
delegating another shared cache instance as a second delegated shared cache instance for determining the winner between the at least two cache algorithms for any access requests associated with the thread;
communicating policy information specifying the winner between the at least two cache algorithms to each of the plurality of cores; and
a shared cache instance, from among the plurality of shared cache instances, upon receiving a request for cache access associated with the thread implementing one of the at least two cache algorithms specified by the policy information received as part of the request for the cache access unless the shared cache instance receiving the request is identified as the first delegated shared cache instance or the second delegated shared cache instance.

16. The method of claim 15, wherein the winner is determined using a first set-dueling counter associated with the first delegated shared cache instance or using a second set-dueling counter associated with the second delegated shared cache instance.

17. The method of claim 15, wherein the winner is determined using a first set-dueling counter associated with the first delegated shared cache instance, and the method further comprising based on one of a cache hit determination or a cache miss determination incrementing or decrementing the first set-dueling counter if the request associated with the thread is accessing a leader set for the first delegated shared cache instance.

18. The method of claim 17, further comprising implementing a policy specified by leader sets for the first delegated shared cache instance if the request associated with the thread is accessing a leader set.

19. The method of claim 15, wherein the winner is determined using a second set-dueling counter associated with the second delegated shared cache instance, and the method further comprising based on one of a cache hit determination or a cache miss determination incrementing or decrementing the second set-dueling counter if the request associated with the thread is accessing a leader set for the second delegated shared cache instance.

20. The method of claim 19, further comprising implementing a policy specified by leader sets for the second delegated shared cache instance if the request associated with the thread is accessing a leader set.
